(19) United States
(12) Patent Application Publication
(10) Pub. No.: US 2017/0335478 A1
(43) Pub. Date: Nov. 23, 2017

(54) ELECTRO-DEPOSITION PROCESS, ELECTRO-DEPOSITION BATH, AND METHOD FOR PREPARING RARE EARTH PERMANENT MAGNETIC MATERIAL THROUGH ELECTRO-DEPOSITION

(71) Applicant: BEIJING ZHONG KE SAN HUAN HI-TECH CO., LTD., Beijing (CN)

(72) Inventors: Peng CHEN, Beijing (CN); Bing JIANG, Beijing (CN); Hong NING, Beijing (CN)

(21) Appl. No.: 15/522,676

(22) PCT Filed: Jul. 20, 2016
(86) PCT No.: PCT/CN2016/090623

§ 371 Date: Apr. 27, 2017

(30) Foreign Application Priority Data
Oct. 21, 2015 (CN) 201510694823.3

(51) Int. Cl. C25D 3/54; H01F 41/02; H01F 1/057

(52) U.S. Cl. CPC C25D 3/54; H01F 1/057; H01F 41/0293

(57) ABSTRACT

The present invention discloses an electro-deposition process, an electro-deposition bath, and a method for preparing a rare earth permanent magnetic material through electro-deposition. The electro-deposition process is used for depositing a heavy rare earth element on the surface of a sintered R²-T-B type master alloy, and comprises Step 1: providing an electro-deposition bath, comprising a main salt containing the heavy rare earth element, an induction salt for inducing the heavy rare earth element to deposit, and an organic ionic liquid as the solvent, wherein the main salt is a tetrafluoroborate of the heavy rare earth element; and Step 2: electroplating the sintered R²-T-B type master alloy in the electro-deposition bath at a temperature of 0 to 200° C. The present invention has the following beneficial effects: deposition of the heavy rare earth element on the surface of the sintered R²-T-B type master alloy is rapid, so that the electro-deposition process time can be saved, and the production efficiency is improved. In addition, a higher plating thickness of up to 10 to 40 μm can be achieved.

### TECHNICAL FIELD

The present invention belongs to the technical field of production methods of rare earth permanent magnetic materials, and particularly relates to an electro-deposition bath, and a method for producing a sintered R-T-B type magnet plated with a heavy rare earth element through electro-deposition.

### BACKGROUND ART

Due to the demand for energy-saving motors in automotive industry and electronic application fields, sintered neodymium iron boron (NdFeB), which is widely used in VCM, motors, signal generators, mobile phones, MRI fields et. al, has been expanded further in the motor market. The improvements of the magnetic properties, such as remanent magnetization and coercive force, facilitate the rapid growth of the sintered magnets in the motor market.

The rare earth-iron-based permanent magnetic materials represented by NdFeB are a new generation of permanent magnetic materials, which have the highest magnetic property (energy density), the widest use, and the most rapid development at present. The intrinsic coercive force (Hcj, referred to as coercive force hereinafter for short) of the magnets can be effectively increased by adding a certain amount of a heavy rare earth element, such as Tb and Dy, to the sintered NdFeB master alloy. Wherein, Nd in grains of the main-phase Nd₂Fe₁₄B of the sintered NdFeB is replaced by the heavy rare earth element, such as Tb and Dy, to form a Dy₂Fe₁₄B and Tb₂Fe₁₄B phase to enhance the anisotropic field of the main phase magnetocrystalline, so as to greatly increase the coercive force of the magnets. However, the direct antiferromagnetic coupling of the heavy rare earth ions and the iron ions causes the remanent magnetization and magnetic energy product of the sintered NdFeB magnet to decrease greatly. Therefore, it is a key research direction of the preparation of sintered NdFeB magnets at present to improve the coercive force by using a heavy rare earth element while preventing the remanent magnetization from decreasing greatly.

In recent years, there are many physical methods, such as magnetron sputtering, vapor deposition, vacuum evaporation and electrochemical processes, to deposit a heavy rare earth element on the surface of a magnetic material, and then to cause the heavy rare earth element to diffuse through the grain boundary into the interior of the magnet by thermal treatment, thereby forming a structure in which the density of the heavy rare earth element decreases rapidly from the exterior to the interior. The resulting intrinsic coercive force of the magnet is remarkably improved while the remanent magnetization is decreased slightly.

The electrochemical process has been one of the focuses researched in the art all the time, because it has many advantages, for example it can control the plating thickness, the amount of the heavy rare earth used in this process is small, and the magnetic material of any shape and size can be processed by this process.

At present, there are two types of electro-deposition methods. In one type, a molten salt is used as the deposition liquid, as described, for example, in Chinese patent application publication No. CN102103916A. This type has the disadvantages of high electro-deposition temperature and large energy consumption in production, and thus it is not suitable for industrialization.

In the other type a solution containing various kinds of organic acid in an organic solvent is used as the deposition liquid. Electroplating can be carried out at room temperature by using methods of this type, as disclosed, for example, in Chinese Patent Application Publication Nos. CN 103617884A and CN 1480564A. The deposition liquid used in these methods is acidic or weakly acidic, which may cause corrosion of the NdFeB master alloy more or less, and need high requirement for the equipment. Moreover, since the deposition liquid is an organic solvent, such electro-deposition usually needs to be carried out at room temperature, and certain requirements are put forward for the effective control of the solution and for the reaction conditions. As such, it is not suitable for industrialization either.

Therefore, there is still a need, in the process for treating an NdFeB master alloy with a heavy rare earth element, to develop a safe and convenient electro-deposition process suitable for industrialization.

### SUMMARY OF THE INVENTION

A first object of the present invention is to provide an electro-deposition process.

A second object of the present invention is to provide an electro-deposition bath.

A third object of the present invention is to provide a method for preparing a sintered R¹R²-T-B type permanent magnetic material.

To accomplish the first object, the present invention provides an electro-deposition process, which is used for depositing a heavy rare earth element on the surface of a sintered R²-T-B type master alloy. The method includes:

Step 1: providing an electro-deposition bath, comprising a main salt containing the heavy rare earth element, an induction salt for inducing the heavy rare earth element to deposit, and an organic ionic liquid as the solvent, where the main salt is a tetrafluoroborate of the heavy rare earth element; and

Step 2: electroplating the sintered R²-T-B type master alloy in the electro-deposition bath at a temperature of 0 to 200° C.

In the electro-deposition process according to the present invention, preferably, the heavy rare earth element is selected from at least one of Gd, Tb, Dy, Ho, Er, Tm, Yb, and Lu, and preferably selected from at least one of Dy, Tb and Ho.

In the electro-deposition process according to the present invention, preferably, the induction salt is Fe(BF₄)₂ and/or Co(BF₄)₂.

In the electro-deposition process according to the present invention, preferably, when the induction salt is Fe(BF₄)₂ and Co(BF₄)₂, the molar concentration of the main salt in the electro-deposition bath is 0.1 to 2 mol/L; the molar concentration of Fe(BF₄)₂ is 0.1 to 2 mol/L; and the molar concentration of Co(BF₄)₂ is 0.1 to 1 mol/L; more preferably, the molar concentration ratio of Fe(BF₄)₂ to Co(BF₄)₂ in the electro-deposition bath is 1 to 2.5:1

In the electro-deposition process according to the present invention, preferably, the organic ionic liquid is selected from at least one of a tetrafluoroborate, a bis[(trifluoromethyl)sulfonyl]imide salt, and a bis(fluorosulfonyl)imide salt.

Preferably, the tetrafluoroborate is selected from N-methoxyethyl-N-methyldiethylammonium tetrafluoroborate or N-methylethylpyrrolidinium tetrafluoroborate.

The bis[(trifluoromethyl)sulfonyl]imide salt is selected from 1-ethyl-3methylimidazolium bis[(trifluoromethyl)sulfonyl]imide, N-methoxyethyl-N-methyldiethylammonium bis[(trifluoromethyl)sulfonyl]imide, trimethylpropylammonium bis[(trifluoromethyl)sulfonyl]imide, trimethylbutylammonium bis[(trifluoromethyl)sulfonyl]imide, N-methylbutylpyrrolidinium bis[(trifluoromethyl)sulfonyl]imide, N-methyl,propylpyrrolidinium bis[(trifluoromethyl)sulfonyl]imide, N-methylethylpyrrolidinium bis[(trifluoromethyl)sulfonyl]imide, N-methylmethoxyethylpyrrolidinium bis[(trifluoromethyl)sulfonyl]imide, N-methylpropylpiperidinium bis[(trifluoromethyl)sulfonyl]imide, N-methylbutylpiperidinium bis[(trifluoromethyl)sulfonyl]imide, and 1,2-dimethyl-3-propylimidazolium bis[(trifluoromethyl)sulfonyl]imide.

The bis(fluorosulfonyl)imide salt is selected from 1-ethyl-3-methylimidazolium bis(fluorosulfonyl)imide, N-methylpropylpyrrolidinium bis(fluorosulfonyl)imide, and N-methylpropylpiperidinium bis(fluorosulfonyl)imide.

In the electro-deposition process according to the present invention, preferably, the electro-deposition bath further comprises a conducting salt. More preferably, the conducting salt is selected from at least one of LiClO₄, LiCl, LiBF₄, KCl, and NaCl.

In the electro-deposition process according to the present invention, preferably, in the process, the cathode is the sintered R²-T-B type master alloy; and the anode may be one of graphite, platinum, silver, and gold.

Preferably, in the sintered R²-T-B type master alloy,

R² is at least one of the rare earth elements, preferably at least one of Sc, Y, La, Ce, Pr, Nd, Pm, Sm, Eu, Gd, Tb, Dy, Ho, Er, Tm, Yb, and Lu, and more preferably Nd or Pr; and is present in an amount of 17 to 38 wt %, based on the weight of the master alloy;

T comprises iron (Fe), which is present in an amount of 55 to 81 wt % based on the weight of the master alloy; and at least one element, which is present in an amount of 0 to 6 wt % based on the weight of the master alloy, selected from Al, Cu, Zn, In, Si, P, S, Ti, V, Cr, Mn, Ni, Ga, Ge, Zr, Nb, Mo, Pd, Ag, Cd, Sn, Sb, Hf, Ta, and W;

B is the elemental boron, which is present in an amount of 0.5 to 1.5 wt % based on the weight of the master alloy; and impurity elements.

In the electro-deposition process according to the present invention, preferably, the electroplating is conducted at a constant voltage of 0.5 to 2V and preferably 0.8 to 1.6V, preferably at a temperature ranging from 0 to 100° C. and preferably from 30 to 40° C., and for a period of time of 20 to 500 min and preferably 50 to 300 min.

In the electro-deposition process according to the present invention, preferably, after Step 2 is completed, the mean thickness of the heavy rare earth element plating on the surface of the sintered R²-T-B type master alloy is 10-40 μm.

To accomplish the second object, the present invention provides an electro-deposition bath, for depositing a heavy rare earth element on the surface of a sintered R²-T-B type master alloy. The electro-deposition bath comprises a main salt containing the heavy rare earth element, an induction salt for inducing the heavy rare earth element to deposit, and an organic ionic liquid as the solvent, where the main salt is a tetrafluoroborate of the heavy rare earth element.

In the electro-deposition bath according to the present invention, preferably,

the heavy rare earth element is at least one selected from Gd, Tb, Dy, Ho, Er, Tm, Yb, and Lu, and preferably selected from at least one of Dy, Tb, and Ho;

the induction salt is Fe(BF₄)₂ and/or Co(BF₄)₂;

the organic ionic liquid is selected from at least one of a tetrafluoroborate, a bis[(trifluoromethyl)sulfonyl]imide salt, and a bis(fluorosulfonyl)imide salt;

preferably, the tetrafluoroborate is selected from N-methoxyethyl-N-methyldiethylammonium tetrafluoroborate or N-methylethylpyrrolidinium tetrafluoroborate;

the bis[(trifluoromethyl)sulfonyl]imide salt is selected from 1-ethyl-3methylimidazolium bis[(trifluoromethyl)sulfonyl]imide, N-methoxyethyl-N-methyldiethylammonium bis[(trifluoromethyl)sulfonyl]imide, trimethylpropylammonium bis[(trifluoromethyl)sulfonyl]imide, trimethylbutylammonium bis[(trifluoromethyl)sulfonyl]imide, N-methylbutylpyrrolidinium bis[(trifluoromethyl)sulfonyl]imide, N-methyl,propylpyrrolidinium bis[(trifluoromethyl)sulfonyl]imide, N-methylethylpyrrolidinium bis[(trifluoromethyl)sulfonyl]imide, N-methylmethoxyethylpyrrolidinium bis[(trifluoromethyl)sulfonyl]imide, N-methylpropylpiperidinium bis[(trifluoromethyl)sulfonyl]imide, N-methylbutylpiperidinium bis[(trifluoromethyl)sulfonyl]imide, and 1,2-dimethyl-3-propylimidazolium bis[(trifluoromethyl)sulfonyl]imide; and

the bis(fluorosulfonyl)imide salt is selected from 1-ethyl-3-methylimidazolium bis(fluorosulfonyl)imide, N-methylpropylpyrrolidinium bis(fluorosulfonyl)imide, and N-methylpropylpiperidinium bis(fluorosulfonyl)imide;

more preferably, the main salt and the induction salt in the electro-deposition bath are formulated in such a manner that the molar concentration of Tb(BF₄)₃ is 0.1 to 2 mol/L, the molar concentration of Fe(BF₄)₂ is 0 to 2 mol/L; and the molar concentration of Co(BF₄)₂ is 0 to 1 mol/L; and

more preferably, the molar concentration ratio of Fe(BF₄)₂ to Co(BF₄)₂ in the electro-deposition bath is 2:1.

In the electro-deposition bath according to the present invention, preferably, the electro-deposition bath further comprises a conducting salt; and more preferably, the conducting salt is selected from at least one of LiClO₄, LiCl, LiBF₄, KCl, and NaCl.

To accomplish the third object, the present invention provides a method for preparing a sintered R¹R²-T-B type permanent magnetic material. The method includes:

Step 1: providing a sintered R²-T-B type master alloy;

Step 2: depositing a heavy rare earth element R¹ on the surface of the R²-T-B type master alloy according to the electro-deposition process as set forth in any one of claims 1 to 11; and

Step 3: performing thermal treatment on the master alloy having the heavy rare earth element R¹ plated on the surface thereof, to obtain the R¹R²-T-B type permanent magnetic material.

Preferably, the thermal treatment includes first-stage high-temperature thermal treatment at 820 to 920° C. under vacuum or under an Ar atmosphere for 1 to 24 hours; and heating and maintaining at a low temperature of 480 to 540° C. for 1 to 10 hours.

The present invention has the following beneficial effects:

Deposition of the heavy rare earth element on the surface of the sintered R²-T-B type master alloy is rapid, so that the electro-deposition process time can be saved, and the production efficiency is improved. In addition, a higher plating thickness of up to 10 to 40 m can be achieved.

Moreover, since an organic ionic liquid is used as the solvent of the electro-deposition bath, the process of the present invention has the advantages of stable solution, wide electrochemical window, high ion conductivity, extremely low vapor pressure, and being non-volatile, non-flammable and non-explosive. Therefore, the electro-deposition can be carried out at a temperature ranging from 0 to 200° C. Furthermore, the organic ionic liquid has an approximately neutral pH, thus causing no corrosion to the master alloy material.

### BRIEF DESCRIPTION OF ACCOMPANYING DRAWINGS

FIG. 1 is an SEM image of a specimen according to an embodiment of the present invention at 100× magnification;

FIG. 2 is an SEM image of a specimen according to an embodiment of the present invention at 300× magnification; and

FIG. 3 is an SEM image of a specimen according to an embodiment of the present invention at 500× magnification.

### DETAILED DESCRIPTION

Hereinafter, the embodiments of the present invention will be described in detail with reference to examples, in which where no specific conditions are defined, the conventional conditions or the conditions recommended by the manufacturer are followed; and the used reagents or instruments with no manufacturer indicated are all conventional products commercially available.

The main salts used in the following examples are obtained by reacting terbium oxide, metallic iron and cobalt carbonate with HBF₄, respectively.

The specific preparation processes are as follows:

The chemical reaction formula for producing Fe(BF₄)₂ is: Fe+2HBF₄═Fe(BF₄)₂+H₂↑.

In the experiment, Fe(BF₄)₂ is produced through a displacement reaction.

Excessive HBF₄ is added into reductive iron powder, then the mixture is heated until the reductive iron powder disappears, and until most of H₂O and HBF₄ are distilled off. After reaction, the system is cooled to room temperature, and heated in a vacuum oven at 100° C. for 15 hours, to obtain Fe(BF₄)₂. The Fe(BF₄)₂ prepared in the experiment is easily oxidized, and thus it should be stored in an inert gas atmosphere. After preparation, the Fe(BF₄)₂ should be used as soon as possible before it is oxidized into Fe(BF₄)₃ to prevent the failure of the experiment.

The chemical reaction formula for producing Co(BF₄)₂ is: CoCO₃+2HBF₄═Co(BF₄)₂+H₂O+CO₂↑.

In the experiment, Co(BF₄)₂ is produced through a metathetical reaction. Excessive HBF₄ is added into CoCO₃, the mixture is heated until the CoCO₃ disappears, and until most of H₂O and HBF₄ are distilled off. After reaction, the system is cooled to room temperature, and heated in a vacuum oven at 100° C. for 15 hours, to obtain Co(BF₄)₂.

The chemical reaction formula for producing Tb(BF₄)₃ is: Tb₂O₃+3HBF₄=2Tb(BF₄)₃+3H₂O.

In the experiment, Tb(BF₄)₃ is produced through a metathetical reaction. Excessive HBF₄ is added into Tb₂O₃. After reaction, the system is cooled to room temperature, and heated in a vacuum oven at 100° C. for 15 hours, to obtain Tb(BF₄)₃.

The following experimental procedures need to be carried out in a glove box. All the experimental processes need to be completed in a stringent environment free of oxygen and water vapor, and the ionic liquid used should be dried for over 2 hours with activated 4A molecular sieve.

### Example 1

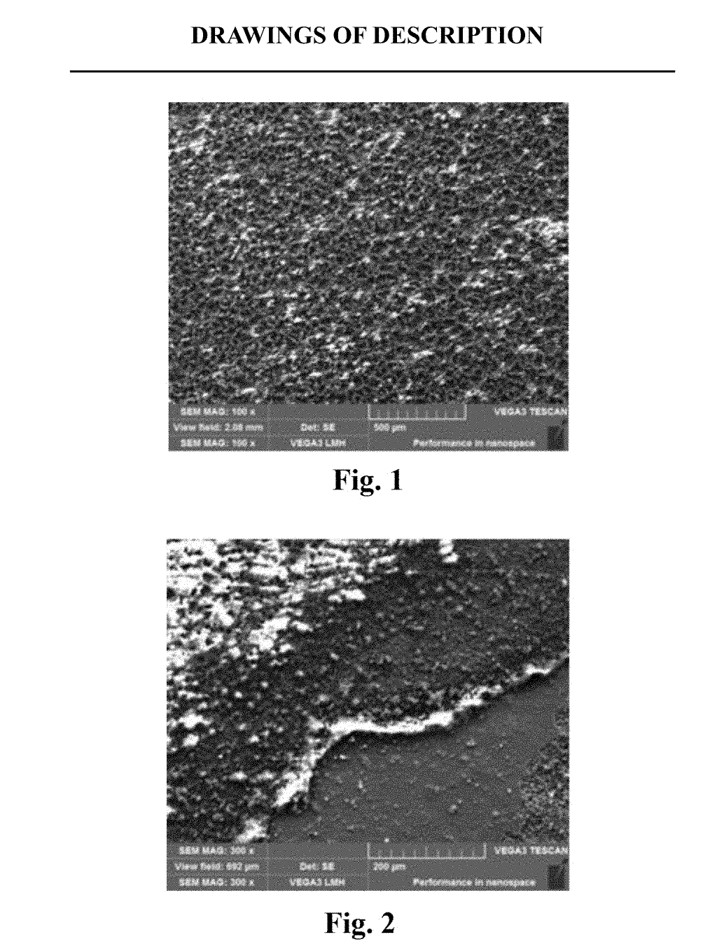

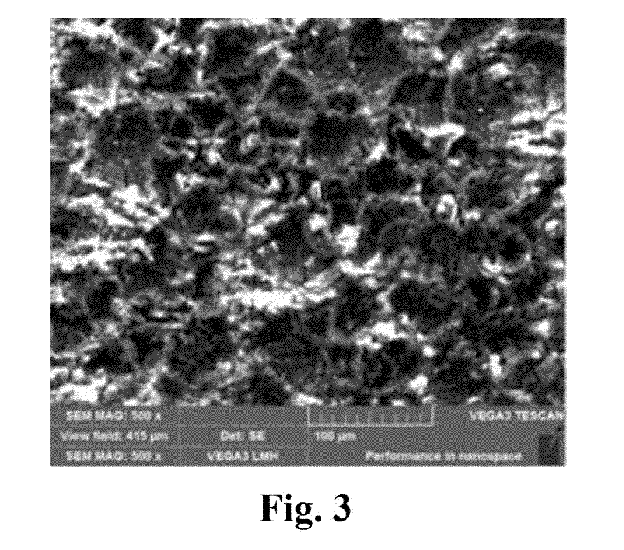

The cathode material used in this example was an R₂FeMB (neodymium iron boron) magnetic material of D7×3 mm, and the anode was a platinum sheet of 10×10×1 mm. The electro-deposition bath contained a main salt comprising a heavy rare earth element, an induction salt for inducing the heavy rare earth element to deposit, and an organic ionic liquid as the solvent. The main salt was a tetrafluoroborate of the heavy rare earth element. In the electro-deposition bath, the molar concentrations of Tb(BF₄)₃, Fe(BF₄)₂, and Co(BF₄)₂ were 1 mol/L, 1.2 mol/L, and 0.6 mol/L respectively, and the ionic liquid was 1-butyl-3-methylimidazolium tetrafluoroborate ([EMIM] BF₄). The electroplating was conducted at a temperature of 50° C. and a constant voltage of 1.9 V for 300 min, to obtain a Fe—Co—Tb plating, as shown in FIG. 1. Its surface was analyzed by EDS. The result is shown in Table 1.1. The thermal treatment process was performed by maintaining at 900° C. for 150 min and then cooling, heating at 480° C. and maintaining at 480° C. for 150 min, followed by cooling. A non-electroplated blank sheet (a blank sheet with no heavy rare earth added in the experiment) was treated with the same thermal treatment process. The comparison results of the properties of the two magnets are shown in Table 1.2.

TABLE 1.1
Energy spectrum analysis results

| | Percent | Atomic |
|---|---|---|
| Element | by weight | percent |
| C K | 4.91 | 15.73 |
| F K | 10.11 | 26.25 |
| Mg K | 0.69 | 0.81 |
| Cl K | 0.18 | 0.15 |
| Fe K | 41.69 | 33.44 |
| Co K | 20.04 | 18.41 |
| Nd L | 5.87 | 1.17 |
| Tb L | 16.51 | 4.04 |

The energy spectrum analysis results show that, the more the content of the heavy rare earth (for example, Tb and so on) is, the better the improvement of the coercive force is.

TABLE 1.2
Magnetic property analysis of
magnetic materials

| Magnetic | Hcj | (BH)ₘₐₓ | | Hk |
|---|---|---|---|---|
| property | (kA/m) | (kJ/m³) | Br (T) | (kA/m) |
| Blank sheet | 1275 | 357.3 | 1.355 | 1234 |
| Magnet | 1355 | 353.6 | 1.351 | 1324 |
| according to | | | | |
| the present | | | | |
| invention | | | | |

### Example 2

The cathode material used in this example was an R₂FeMB (neodymium iron boron) magnetic material of D7×3 mm, and the anode was a platinum sheet of 10 10×1 mm. The electro-deposition bath contained a main salt comprising a heavy rare earth element, an induction salt for inducing the heavy rare earth element to deposit, and an organic ionic liquid as the solvent. The main salt was a tetrafluoroborate of the heavy rare earth element. In the electro-deposition bath, the molar concentrations of Tb(BF₄)₃, Fe(BF₄)₂, and Co(BF₄)₂ were 0.5 mol/L, 1 mol/L, and 0.5 mol/L respectively, and the ionic liquid was N-methylethylpyrrolidinium tetrafluoroborate. The electroplating was conducted at a temperature of 0° C. and a constant voltage of 0.5 V for 500 min, to obtain a Fe—Co—Tb plating. The thermal treatment process was performed by maintaining at 820° C. for 24 hours and then cooling, heating at 540° C. and maintaining at 540° C. for 1 hour, followed by cooling. An R₁R₂FeMB magnetic material was obtained by forming a network-like granular crystalline plating of about 10-30 μm in thickness on the surface of R₂FeMB through the electro-deposition process described in this example. A non-electroplated blank sheet (a blank sheet with no heavy rare earth added in the experiment) was treated with the same thermal treatment process. The comparison results of the properties of the two magnets are shown in Table 2.

TABLE 2
Magnetic property analysis
of magnetic materials

| Magnetic | Hcj | (BH)max | | Hk |
|---|---|---|---|---|
| property | (kA/m) | (kJ/m³) | Br (T) | (kA/m) |
| Blank sheet | 1291 | 356.4 | 1.352 | 1259 |
| Magnet | 1435 | 351.6 | 1.348 | 1396 |
| according to | | | | |
| the present | | | | |
| invention | | | | |

### Example 3

The cathode material used in this example was an R₂FeMB (neodymium iron boron) magnetic material of D7×3 mm, and the anode was a platinum sheet of 10×10×1 mm. The electro-deposition bath contained a main salt comprising a heavy rare earth element, an induction salt for inducing the heavy rare earth element to deposit, and an organic ionic liquid as the solvent. The main salt was a tetrafluoroborate of the heavy rare earth element. In the electro-deposition bath, the molar concentrations of Tb(BF₄)₃, Fe(BF₄)₂, and Co(BF₄)₂ were 0.2 mol/L, 0.5 mol/L, and 0.1 mol/L respectively, and the ionic liquid was 1-ethyl-3methylimidazolium bis[(trifluoromethyl)sulfonyl]imide. The electroplating was conducted at a temperature of 200° C. and a constant voltage of 2 V for 350 min, to obtain a Fe—Co—Tb plating. The thermal treatment process was performed by maintaining at 920° C. for 1 hour and then cooling, heating at 480° C. and maintaining at 480° C. for 10 hours, followed by cooling. An R₁R₂FeMB magnetic material was obtained by forming a network-like granular crystalline plating of about 10-30 m in thickness on the surface of R₂FeMB through the electro-deposition process described in this example. A non-electroplated blank sheet (a blank sheet with no heavy rare earth added in the experiment) was treated with the same thermal treatment process. The comparison results of the properties of the two magnets are shown in Table 3.

TABLE 3
Magnetic property analysis
of magnetic materials

| Magnetic | Hcj | (BH)max | | Hk |
|---|---|---|---|---|
| property | (kA/m) | (kJ/m³) | Br (T) | (kA/m) |
| Blank sheet | 1370 | 353.8 | 1.352 | 1331 |
| Magnet | 1515 | 350.4 | 1.349 | 1460 |
| according to | | | | |
| the present | | | | |
| invention | | | | |

### Example 4

The cathode material used in this example was an R₂FeMB (neodymium iron boron) magnetic material of D7×3 mm, and the anode was a platinum sheet of 10 10×1 mm. The electro-deposition bath contained a main salt comprising a heavy rare earth element, an induction salt for inducing the heavy rare earth element to deposit, and an organic ionic liquid as the solvent. The main salt was a tetrafluoroborate of the heavy rare earth element. In the electro-deposition bath, the molar concentrations of Tb(BF₄)₃, Co(BF₄)₂, and Fe(BF₄)₂ were 0.5 mol/L, 0.3 mol/L, and 0.8 mol/L respectively, and the ionic liquid was trimethylbutylammonium bis[(trifluoromethyl)sulfonyl]imide. The electroplating was conducted at a temperature of 80° C. and a constant voltage of 0.8 V for 200 min, to obtain a Fe—Co—Tb plating. The thermal treatment process was performed by maintaining at 900° C. for 5 hours and then cooling, heating at 500° C. and maintaining at 500° C. for 6 hours, followed by cooling. An R₁R₂FeMB magnetic material was obtained by forming a network-like granular crystalline plating of about 10-30 μm in thickness on the surface of R₂FeMB through the electro-deposition process described in this example. A non-electroplated blank sheet (a blank sheet with no heavy rare earth added in the experiment) was treated with the same thermal treatment process. The comparison results of the properties of the two magnets are shown in Table 4.

TABLE 4
Magnetic property analysis
of magnetic materials

| Magnetic | Hcj | (BH)max | | Hk |
|---|---|---|---|---|
| property | (kA/m) | (kJ/m³) | Br (T) | (kA/m) |
| Blank sheet | 1285 | 354.7 | 1.359 | 1250 |
| Magnet | 1435 | 351.1 | 1.351 | 1379 |
| according | | | | |
| to the present | | | | |
| invention | | | | |

### Example 5

The cathode material used in this example was an R₂FeMB (neodymium iron boron) magnetic material of D7×3 mm, and the anode was a platinum sheet of 10×10×1 mm. The electro-deposition bath contained a main salt comprising a heavy rare earth element, an induction salt for inducing the heavy rare earth element to deposit, and an organic ionic liquid as the solvent. The main salt was a tetrafluoroborate of the heavy rare earth element. In the electro-deposition bath, the molar concentrations of Tb(BF₄)₃, Co(BF₄)₂, and Fe(BF₄)₂ were 1 mol/L, 1 mol/L, and 1.2 mol/L respectively, and the ionic liquid was 1-ethyl-3-methylimidazolium bis(fluorosulfonyl)imide. The electroplating was conducted at a temperature of 120° C. and a constant voltage of 1.6 V for 500 min, to obtain a Fe—Co—Tb plating. The thermal treatment process was performed by maintaining at 890° C. for 20 hours and then cooling, heating at 490° C. and maintaining at 490° C. for 8 hours, followed by cooling. An R₁R₂FeMB magnetic material was obtained by forming a network-like granular crystalline plating of about 10-30 μm in thickness on the surface of R₂FeMB through the electro-deposition process described in this example. A non-electroplated blank sheet (a blank sheet with no heavy rare earth added in the experiment) was treated with the same thermal treatment process. The comparison results of the properties of the two magnets are shown in Table 5.

TABLE 5
Magnetic property analysis
of magnetic materials

| Magnetic | Hcj | (BH)max | | Hk |
|---|---|---|---|---|
| property | (kA/m) | (kJ/m³) | Br (T) | (kA/m) |
| Blank sheet | 1272 | 357.6 | 1.352 | 1196 |
| Magnet | 1435 | 350.1 | 1.347 | 1365 |
| according to | | | | |
| the present | | | | |
| invention | | | | |

### Example 6

The cathode material used in this example was an R₂FeMB (neodymium iron boron) magnetic material of D7×3 mm, and the anode was a platinum sheet of 10×10×1 mm. The electro-deposition bath contained a main salt comprising a heavy rare earth element, an induction salt for inducing the heavy rare earth element to deposit, an organic ionic liquid as the solvent, and a conducting salt. The main salt was a tetrafluoroborate of the heavy rare earth element. In the electro-deposition bath, the molar concentrations of Tb(BF₄)₃, Fe(BF₄)₂, and Co(BF₄)₂ were 1 mol/L, 2 mol/L, and 1 mol/L respectively. The ionic liquid was N-methylethylpyrrolidinium bis[(trifluoromethyl)sulfonyl]imide, and the conducting salt NaCl had a concentration of 0.5 mol/L. The electroplating was conducted at a temperature of 150° C. and a constant voltage of 1.5 V for 300 min, to obtain a Fe—Co—Tb plating. The thermal treatment process was performed by maintaining at 900° C. for 3 hours and then cooling, heating at 480° C. and maintaining at 480° C. for 2 hours, followed by cooling. An R₁R₂FeMB magnetic material was obtained by forming a network-like granular crystalline plating of about 10-30 m in thickness on the surface of R₂FeMB through the electro-deposition process described in this example. A non-electroplated blank sheet (a blank sheet with no heavy rare earth added in the experiment) was treated with the same thermal treatment process. The comparison results of the properties of the two magnets are shown in Table 6.

TABLE 6
Magnetic property analysis
of magnetic materials

| Magnetic | Hcj | (BH)max | | Hk |
|---|---|---|---|---|
| property | (kA/m) | (kJ/m³) | Br (T) | (kA/m) |
| Blank sheet | 1410 | 344.8 | 1.341 | 1334 |
| Magnet | 1595 | 339.4 | 1.335 | 1516 |
| according to | | | | |
| the present | | | | |
| invention | | | | |

In the above examples, the experimental results show that the coercive force Hcj of the magnets prepared through the electro-deposition process of the present invention have been improved, while there is little influence on the remanent magnetization Br.

In addition, it should be noted that with the same temperature and the same organic solvent, the solubility of the tetrafluoroborate of a heavy rare earth element (for example, Tb(BF₄)₃) is about ten times of the solubility of other kinds of heavy rare earth salt (for example, TbCl₃). The solubility of Tb(BF₄)₃ is generally about 1 mol/L, and the solubility of TbCl₃ is about 0.1 mol/L. With the same period of time (for example, the electro-deposition time is 60 min), a plating with a thickness of about 10 m can be formed in a system having Tb(BF₄)₃ as the main salt, while a plating with a thickness of only about 1 m is formed in a system having TbCl₃ as the main salt. Even though the former is an alloy, and the content of the heavy rare earth is about 15-20%, the rate in the former case is still 1 time faster than that in the latter case. Furthermore, considering the high solubility, the supplementation time cycle of the main salt during production can be extended, which desirably meets the practical requirement in massive production.

The above embodiments are merely exemplary embodiments of the present invention and are not intended to limit the protection scope of the invention, which is defined by the claims. Various modifications or equivalent substitutions may be made to the present invention by a person skilled in the art within the spirit and protection scope of the present invention, and such modifications or equivalent substitutions are also deemed to fall within the protection scope of the present invention.

1. An electro-deposition process for depositing a heavy rare earth element on the surface of a sintered R²-T-B type master alloy, comprising:
Step 1: providing an electro-deposition bath, comprising a main salt containing the heavy rare earth element, an induction salt for inducing the heavy rare earth element to deposit, and an organic ionic liquid as the solvent, wherein the main salt is a tetrafluoroborate of the heavy rare earth element; and
Step 2: electroplating the sintered R²-T-B type master alloy in the electro-deposition bath at a temperature of 0 to 200° C.

2. The electro-deposition process according to claim 1, wherein the heavy rare earth element is selected from at least one of Gd, Tb, Dy, Ho, Er, Tm, Yb, and Lu, and preferably selected from at least one of Dy, Tb, and Ho.

3. The electro-deposition process according to claim 1, wherein the induction salt is Fe(BF₄)₂ and/or Co(BF₄)₂.

4. The electro-deposition process according to claim 1, wherein when the induction salt is Fe(BF₄)₂ and Co(BF₄)₂, the molar concentration of the main salt in the electro-deposition bath is 0.1 to 2 mol/L; the molar concentration of Fe(BF₄)₂ is 0.1 to 2 mol/L; and the molar concentration of Co(BF₄)₂ is 0.1 to 1 mol/L.

5. The electro-deposition process according to claim 4, wherein the molar concentration ratio of Fe(BF₄)₂ to Co(BF₄)₂ in the electro-deposition bath is 1 to 2.5:1.

6. The electro-deposition process according to claim 1, wherein the organic ionic liquid is selected from at least one of a tetrafluoroborate, a bis[(trifluoromethyl)sulfonyl]imide salt, and a bis(fluorosulfonyl)imide salt;
preferably, the tetrafluoroborate is selected from N-methoxyethyl-N-methyldiethylammonium tetrafluoroborate or N-methylethylpyrrolidinium tetrafluoroborate;
the bis[(trifluoromethyl)sulfonyl]imide salt is selected from 1-ethyl-3methylimidazolium bis[(trifluoromethyl)sulfonyl]imide, N-methoxyethyl-N-methyldiethylammonium bis[(trifluoromethyl)sulfonyl]imide, trimethylpropylammonium bis[(trifluoromethyl)sulfonyl]imide, trimethylbutylammonium bis[(trifluoromethyl)sulfonyl]imide, N-methylbutylpyrrolidinium bis[(trifluoromethyl)sulfonyl]imide, N-methyl,propylpyrrolidinium bis[(trifluoromethyl)sulfonyl]imide, N-methylethylpyrrolidinium bis[(trifluoromethyl)sulfonyl]imide, N-methylmethoxyethylpyrrolidinium bis[(trifluoromethyl)sulfonyl]imide, N-methylpropylpiperidinium bis[(trifluoromethyl)sulfonyl]imide, N-methylbutylpiperidinium bis[(trifluoromethyl)sulfonyl]imide, and 1,2-dimethyl-3-propylimidazolium bis[(trifluoromethyl)sulfonyl]imide; and
the bis(fluorosulfonyl)imide salt is selected from 1-ethyl-3-methylimidazolium bis(fluorosulfonyl)imide, N-methylpropylpyrrolidinium bis(fluorosulfonyl)imide, and N-methylpropylpiperidinium bis(fluorosulfonyl)imide.

7. The electro-deposition process according to claim 1, wherein the electro-deposition bath further comprises a conducting salt.

8. The electro-deposition process according to claim 7, wherein the conducting salt is selected from at least one of LiClO₄, LiCl, LiBF₄, KCl, and NaCl.

9. The electro-deposition process according to claim 1, wherein, in the process, the cathode is the sintered R²-T-B type master alloy; and the anode may be one of graphite, platinum, silver, and gold,
preferably, in the sintered R²-T-B type master alloy, wherein
R² is at least one of the rare earth elements, preferably at least one of Sc, Y, La, Ce, Pr, Nd, Pm, Sm, Eu, Gd, Tb, Dy, Ho, Er, Tm, Yb, and Lu, and more preferably Nd or Pr; and is present in an amount of 17 to 38 wt % based on the weight of the master alloy;
T comprises iron (Fe), which is present in an amount of 55 to 81 wt % based on the weight of the master alloy; and at least one element, which is present in an amount of 0 to 6 wt % based on the weight of the master alloy, selected from Al, Cu, Zn, In, Si, P, S, Ti, V, Cr, Mn, Ni, Ga, Ge, Zr, Nb, Mo, Pd, Ag, Cd, Sn, Sb, Hf, Ta, and W;
B is the elemental boron, which is present in an amount of 0.5 to 1.5 wt % based on the weight of the master alloy; and
impurity elements.

10. The electro-deposition process according to claim 1, wherein the electroplating is conducted at a constant voltage of 0.5 to 2 V and preferably 0.8 to 1.6 V, preferably at a temperature ranging from 0 to 100° C. and more preferably from 30 to 40° C., and for a period of time of 20 to 500 min and preferably 50 to 300 min.

11. The electro-deposition process according to claim 1, wherein after Step 2 is completed, the mean thickness of the heavy rare earth element plating on the surface of the sintered R²-T-B type master alloy is 10-40 m.

12. An electro-deposition bath for depositing a heavy rare earth element on the surface of a sintered R²-T-B type master alloy, comprising a main salt containing the heavy rare earth element, an induction salt for inducing the heavy rare earth element to deposit, and an organic ionic liquid as the solvent, wherein the main salt is a tetrafluoroborate of the heavy rare earth element.

13. The electro-deposition bath according to claim 12, wherein
the heavy rare earth element is selected from at least one of Gd, Tb, Dy, Ho, Er, Tm, Yb, and Lu, and preferably selected from at least one of Dy, Tb, and Ho;
the induction salt is Fe(BF₄)₂ and/or Co(BF₄)₂;
the organic ionic liquid is selected from at least one of a tetrafluoroborate, a bis[(trifluoromethyl)sulfonyl]imide salt, and a bis(fluorosulfonyl)imide salt;
preferably, the tetrafluoroborate is selected from N-methoxyethyl-N-methyldiethylammonium tetrafluoroborate or N-methylethylpyrrolidinium tetrafluoroborate;
the bis[(trifluoromethyl)sulfonyl]imide salt is selected from 1-ethyl-3methylimidazolium bis[(trifluoromethyl)sulfonyl]imide, N-methoxyethyl-N-methyldiethylammonium bis[(trifluoromethyl)sulfonyl]imide, trimethylpropylammonium bis[(trifluoromethyl)sulfonyl]imide, trimethylbutylammonium bis[(trifluoromethyl)sulfonyl]imide, N-methylbutylpyrrolidinium bis[(trifluoromethyl)sulfonyl]imide, N-methyl,propylpyrrolidinium bis[(trifluoromethyl)sulfonyl]imide, N-methylethylpyrrolidinium bis[(trifluoromethyl)sulfonyl]imide, N-methylmethoxyethylpyrrolidinium bis[(trifluoromethyl)sulfonyl]imide, N-methylpropylpiperidinium bis[(trifluoromethyl)sulfonyl]imide, N-methylbutylpiperidinium bis[(trifluoromethyl)sulfonyl]imide, and 1,2-dimethyl-3-propylimidazolium bis[(trifluoromethyl)sulfonyl]imide; and
the bis(fluorosulfonyl)imide salt is selected from 1-ethyl-3-methylimidazolium bis(fluorosulfonyl)imide, N-methylpropylpyrrolidinium bis(fluorosulfonyl)imide, and N-methylpropylpiperidinium bis(fluorosulfonyl)imide;
more preferably, the main salt and the induction salt in the electro-deposition bath are formulated in such a manner that the molar concentration of Tb(BF₄)₃ is 0.1 to 2 mol/L, the molar concentration of Fe(BF₄)₂ is 0 to 2 mol/L, and the molar concentration of Co(BF₄)₂ is 0 to 1 mol/L; and
more preferably, the molar concentration ratio of Fe(BF₄)₂ to Co(BF₄)₂ in the electro-deposition bath is 2:1.

14. The electro-deposition bath according to claim 13, further comprising a conducting salt; and preferably the conducting salt is selected from at least one of LiClO₄, LiCl, LiBF₄, KCl, and NaCl.

15. A method for preparing a sintered R¹R²-T-B type permanent magnetic material, comprising:
Step 1: providing a sintered R²-T-B type master alloy;
Step 2: depositing a heavy rare earth element R¹ on the surface of the R²-T-B type master alloy according to the electro-deposition process as set forth in claim 1; and
Step 3: performing thermal treatment on the master alloy having the heavy rare earth element R¹ plated on the surface thereof, to obtain the R¹R²-T-B type permanent magnetic material;
preferably, the thermal treatment comprises first-stage high-temperature thermal treatment at 820 to 920° C. under vacuum or under an Ar atmosphere for 1 to 24 hours; and heating and maintaining at a low temperature of 480 to 540° C. for 1 to 10 hours.
